(19) United States
(12) Patent Application Publication
(10) Pub. No.: US 2025/0131945 A1
(43) Pub. Date: Apr. 24, 2025

(54) COVER AND RECORDING DEVICE

(71) Applicant: NHK SPRING CO., LTD., Yokohama-shi, Kanagawa (JP)

(72) Inventors: Toshimitsu ARAKI, Yokohama-shi, Kanagawa (JP); Osamu OKAWARA, Yokohama-shi, Kanagawa (JP); Shuji TAKAHASHI, Yokohama-shi, Kanagawa (JP)

(21) Appl. No.: 18/682,399

(22) PCT Filed: Aug. 23, 2022
(86) PCT No.: PCT/JP2022/031716

§ 371 Date: Feb. 8, 2024

(30) Foreign Application Priority Data
Aug. 27, 2021 (JP) 2021-139214

(51) Int. Cl. G11B 33/02; G11B 33/14

(52) U.S. Cl. CPC G11B 33/027; G11B 33/1466; G11B 2220/2516

(57) ABSTRACT

Provided is a cover capable of adapting to a case requiring properties hard to be compatible for a gasket of a recording device. The cover attached to a base of a recording device to close the base, comprises a gasket having a loop shape and provided to a cover body, wherein the gasket has an inner gasket portion and an outer gasket portion arranged adjacent to each other on an inward side and an outward side of the loop shape, the outer gasket portion has a first property and a second property that are different properties and is superior to the inner gasket portion in the first property, and the inner gasket portion has the first property and the second property and is superior to the outer gasket portion in the second property.

### FIELD OF THE INVENTION

The present invention relates to a cover used for a recording device such as hard disk drive and a recording device having the cover.

### BACKGROUND OF THE INVENTION

A hard disk drive as a recording device requires sealability so that dust and moisture are not entered into a space accommodating disks as recording media.

In order to ensure the sealability, a gasket is provided between a base plate (base) and a cover plate (cover) that define a space as Patent document 1, for example.

On the other hand, a recent hard disk drive may enclose helium gas or the like that has resistance lower than air in a space. In this case, it is required that the helium gas or the like is prevented from being discharged to the outside from the space.

For this, a gasket for a hard disk drive may require not only a vapor barrier property to suppress entry of moisture but also a gas barrier property to suppress discharge of gas. It should be noted that the gas barrier property is hardness of permeation of the gas sealed in the hard disk drive and the vapor barrier property is hardness of permeation of moisture including vapor.

It is, however, hard that the gas barrier property and the vapor barrier property required for the hard disk drive are compatible in the gasket.

Such a problem of compatibility may be issued on not only the gas barrier property and the vapor barrier property but other properties such as hardness, peel strength, viscosity, heat resistance, pressure resistance and the like required for a gasket.
PATENT LITERATURE 1: JP5179120B

### SUMMARY OF THE INVENTION

A problem to be solved is that it is difficult to adapt to a case requiring properties hard to be compatible for a gasket of a recording device.

The present invention provides a cover attached to a base of a recording device to close the base, comprising a cover body, a gasket having a loop shape and provided to the cover body. The gasket has an inner gasket portion and an outer gasket portion arranged adjacent to each other on an inward side and an outward side of the loop shape, the outer gasket portion has a first property and a second property that are different properties and is superior to the inner gasket portion in the first property, and the inner gasket portion has the first property and the second property and is superior to the outer gasket portion in the second property.

Further, the present invention provides a recording device having the above cover, comprising a base to which the cover is attached to be closed, and a gasket-receiving portion provided to the base to hold the gasket between the cover body and the gasket-receiving portion.

The present invention adapts to a case requiring properties hard to be compatible for a gasket of a recording device.

### BRIEF DESCRIPTION OF THE DRAWINGS

FIG. 1 is a schematic sectional view of a disk device according to an embodiment 1 of the present invention;

FIG. 2 is a schematic sectional view illustrating a gasket of FIG. 1 and a periphery thereof with enlargement;

FIG. 3 is a schematic sectional view illustrating a portion corresponding to FIG. 2 in a state before a cover is attached;

FIG. 4 is a bottom view of the cover used for the disk device of FIG. 1;

FIG. 5 is a schematic sectional view illustrating a gasket and a periphery thereof of a disk device according to an embodiment 2 of the present invention with enlargement;

FIG. 6 is a schematic sectional view illustrating a gasket and a periphery thereof of a disk device according to an embodiment 3 of the present invention with enlargement;

FIG. 7 is a schematic sectional view illustrating a portion corresponding to FIG. 6 in a state before a cover is attached; and

FIG. 8 is a schematic sectional view illustrating a gasket and a periphery thereof of a disk device according to an embodiment 4 of the present invention with enlargement.

### EMBODIMENT FOR CARRYING OUT THE INVENTION

The object of adapting to a case requiring properties hard to be compatible for a gasket of a recording device is accomplished by providing a gasket having a loop shape with an inner gasket portion and an outer gasket portion arranged adjacent to each other on an inward side and an outward side, the outer gasket portion being superior in a first property and the inner gasket portion being superior in the second property.

Namely, a cover (11) attached to a base (9) of a recording device (1) to close the base (9), comprises a cover body (19), a gasket (21) having a loop shape and provided to the cover body (19). The gasket (21) has an inner gasket portion (25) and an outer gasket portion (23) arranged adjacent to each other on an inward side and an outward side of the loop shape. The outer gasket portion (23) has a first property and a second property that are different properties and is superior to the inner gasket portion (25) in the first property, and the inner gasket portion (25) has the first property and the second property and is superior to the outer gasket portion (23) in the second property.

The first property may be one of a gas barrier property and a vapor barrier property, the gas barrier property being hardness of permeation of gas sealed in the recording device (1) and the vapor barrier property being hardness of permeation of moisture, and the second property may be the other of the gas barrier property and the vapor barrier property.

The outer gasket portion (23) may be configured to be higher than the inner gasket portion (25) in height from the cover body (19) in a free state.

Further, the outer gasket portion (23) and the inner gasket portion (25) may be configured to be provided in degrees to supplement each other inferiors of the first property and the second property.

A recording device (1) having the cover (11), comprises a base (9) to which the cover (11) is attached to be closed, and a gasket-receiving portion (17) provided to the base (9) to hold the gasket (21) between the cover body (19) and the gasket-receiving portion.

Both the outer gasket portion (23) and the inner gasket portion (25) of the gasket (21) may be held between the cover body (19) and the gasket-receiving portion (17).

Instead, only the outer gasket portion (23) may be held between the cover body (19) and the gasket-receiving portion (17).

In any case, both the outer gasket portion (23) and the inner gasket portion (25) may be configured to be located in a range of an interspace between the cover body (19) and the gasket-receiving portion (17).

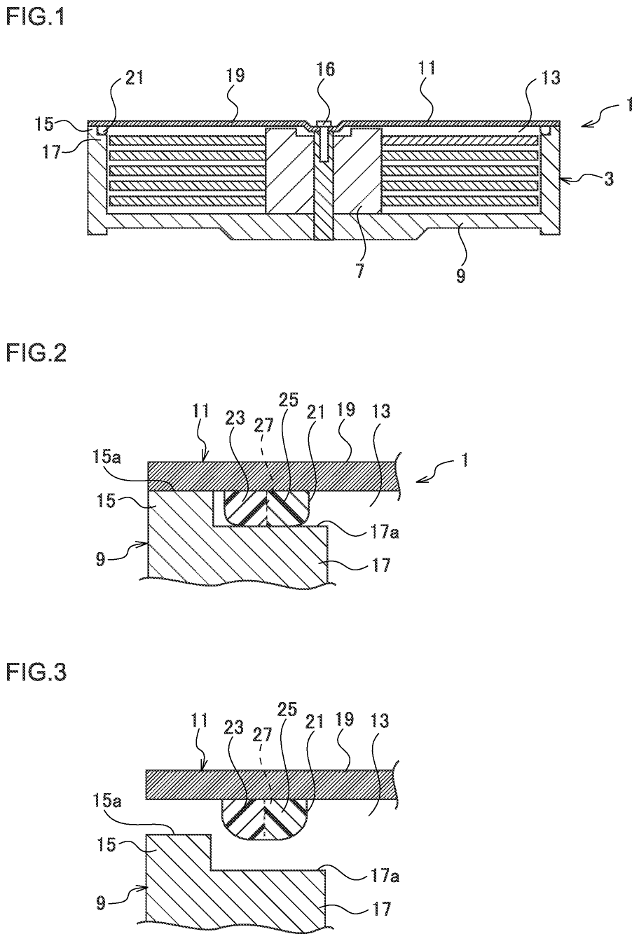

FIG. 1 is a schematic sectional view of a disk device as a recording device according to the embodiment 1 of the present invention, FIG. 2 is a schematic sectional view illustrating a principal part of the disk device 1 of FIG. 1 with enlargement, and FIG. 3 is a schematic sectional view illustrating a portion corresponding to FIG. 2 in a state before a cover is attached.

The disk device 1 as the recording device according to the present embodiment 1 is a hard disk drive as a magnetic disk device and accommodates disks 5 as recording media in a space 13 within a housing 3.

It should be noted that the disk device 1 is not limited to the magnetic disk device and may be the other disk drive such as an optical disk device. Further, the recording device may be a recording device using a magnetic tape or the like other than the disk device 1.

In the disk device 1, a plurality of disks 5 are stacked in a thickness direction of the disk device 1 (hereinafter, simply referred to as “thickness direction”) and is configured to be rotatably supported by a spindle motor 7. The disks 5 are configured so that information are read and written through heads not illustrated.

The housing 3 comprises a base 9 and a cover 11.

The base 9 is made of metal such as aluminum and is formed into a box shape opening on one side in the thickness direction. The base 9 may employ an appropriate shape as long as the base should be a box shape capable of accommodating disks 5. The base 9 of the present embodiment is an approximate rectangular shape in a plan view, for example. In addition, the plan view means a state seen in the thickness direction and does not mean to distinguish a plan and a bottom.

The base 9 is closed by the cover 11 attached to the opening on the one side in the thickness direction. This seals the space 13 in the housing 3 accommodating the disks 5. Gas such as helium having resistance less than of air is sealed in the sealed space 13 (in the disk device 1).

An opening edge of the base 9 is provided with a cover-receiving portion 15 and a gasket-receiving portion 17.

The cover-receiving portion 15 is protruded in the thickness direction of the base 9 and is provided along an outer periphery of the base 9 to have a loop shape. It should be noted that the cover-receiving portion 15 may not be necessarily the loop shape as long as the cover-receiving portion is capable of receiving the cover 11.

The cover-receiving portion 15 receives the cover 11 at a tip end 15a in the thickness direction by putting the cover thereon in the thickness direction. In the present embodiment, the tip end 15a of the cover-receiving portion 15 is configured by a flat face along an intersecting direction intersecting the thickness direction.

It should be noted that the tip end 15a of the cover-receiving portion 15 may not be necessarily the flat face as long as the tip end receives the cover 11 in the thickness direction. Further, the intersecting direction includes both a direction orthogonal to the thickness direction and a direction slightly tilting relatively to the direction orthogonal to the thickness direction. The cover-receiving portion 15 may be omitted.

The gasket-receiving portion 17 receives a gasket 21 of the cover 11. The gasket 21 is held between the gasket-receiving portion 17 and a cover body 19 of the cover 11. The gasket-receiving portion 17 of the present embodiment is provided along the outer periphery of the base 9 to have a loop shape.

The gasket-receiving portion 17 has a receiving face 17a oriented toward the cover 11 in the thickness direction. The receiving face 17a is formed flat along the intersecting direction intersecting the thickness direction, the orthogonal direction in the present embodiment. With this receiving face 17a, the gasket 21 is received. It should be noted that the receiving face 17a may not be flat and may have irregularities or the like as long as the receiving face receives the gasket 21. Further, the intersecting direction may not be necessarily the orthogonal direction as long as the receiving face 17a receives the gasket 21.

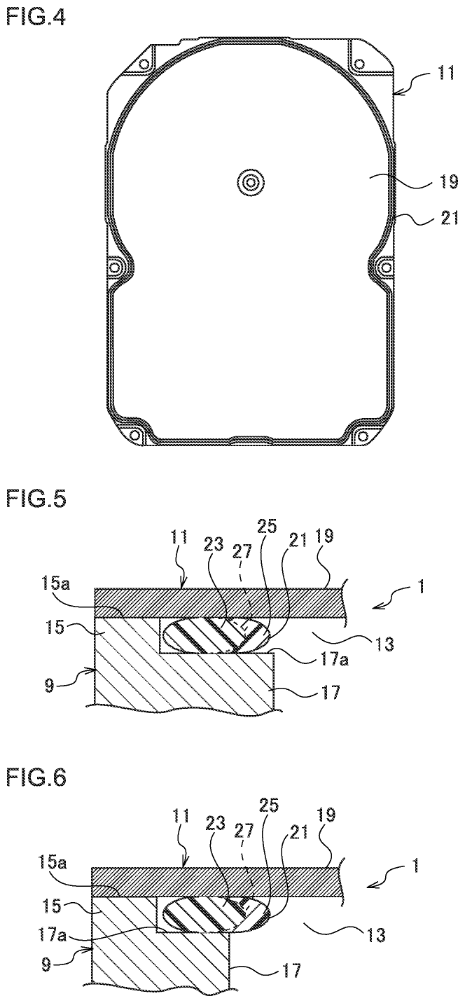

FIG. 4 is a bottom view of the cover 11.

The cover 11 is provided with the cover body 19 and the gasket 21 as illustrated in FIGS. 1-4.

The cover body 19 is made of metal such as aluminum and is formed into a plate shape to cover the opening of the base 9. The cover body 19 of the present embodiment is in an approximate rectangular shape in the plan view. The shape of the cover body 19 is, however, not limited to a particular shape as long as it cover the opening of the base 9.

The cover body 19 is received at an outer peripheral edge thereof by the cover-receiving portion 15 of the base 9 in the thickness direction in a state that the cover body covers the opening of the base 9. In this state, the cover body 19 is fixed to the base 9 using fasteners 16 such as bolts.

The gasket 21 seals a gap between the cover 11 and the base 9. According to the present embodiment, the gasket 21 is held between the cover body 19 and the gasket-receiving portion 17 of the base 9. With this, the gasket 21 seals the gap between the cover body 19 and the gasket-receiving portion 17. A shape (planar shape) of the gasket 21 in the plan view is one corresponding to the gap between the cover 11 and the base 9. According to the present embodiment, the planar shape of the gasket 21 is a loop shape as a whole formed to the cover body 19. The gasket 21 comprises an outer gasket portion 23 and an inner gasket portion 25.

The outer gasket portion 23 and the inner gasket portion 25 are made of liquid gaskets such as urethane-acrylate-based liquid gaskets and polyolefin-based elastomers. The outer gasket portion 23 and the inner gasket portion 25 are formed by curing the liquid gaskets applied to the cover body 19 by injection molding or the like. The whole gasket 21 that is the outer gasket portion 23 and the inner gasket portion 25 in the cured state has an approximate rectangular section with rounded corners in a free state.

It should be noted that the liquid gasket may be the other liquid gasket such as silicone-based one or the like. Further, the outer gasket portion 23 and the inner gasket portion 25 may be molded gaskets. The molded gaskets may be adhered to the cover body 19. Furthermore, one of the outer gasket portion 23 and the inner gasket portion 25 may be the liquid gasket and the other may be the molded gasket.

The outer gasket portion 23 and the inner gasket portion 25 are arranged adjacent to each other on an inward side and an outward side of the loop shape (the inward side and the outward side in the intersecting direction relative to the thickness direction).

According to the embodiment, the outer gasket portion 23 and the inner gasket portion 25 are tightly contact and adjacent to each other. With this, the inner gasket portion 25 entirely covers an inner side of the outer gasket portion 23. The covering in this context is that the outer gasket portion is prevented from being exposed to the disk space 13.

The outer gasket portion 23 and the inner gasket portion 25 occupy an outer half and an inner half of the gasket 21 in the intersecting direction relative to the thickness direction, respectively. A boundary surface 27 is formed along the thickness direction on a boundary between the outer gasket portion 23 and the inner gasket portion 25. The boundary between the outer gasket portion 23 and the inner gasket portion 25 being the liquid gaskets may have, however, no boundary face 27 and be a state mixed with each other. Further, the outer gasket portion 23 and the inner gasket portion 25 may not be tightly contact and may be adjacent with interposition of a gap therebetween.

The outer gasket portion 23 has a first property and a second property that are different properties and is superior to the inner gasket portion 25 in the first property. The inner gasket portion 25 has the first property and the second property and is superior to the outer gasket portion 23 in the second property.

The first property and the second property are hard to be compatible in a level required for the disk device 1 and are provided in both the outer gasket portion 23 and the inner gasket portion 25. According to the present embodiment, the first property is a gas barrier property and the second property is a vapor barrier property. The gas barrier property is hardness of permeation of the gas sealed in the disk device 1 and the vapor barrier property is hardness of permeation of moisture. The moisture in this context includes both gas (vapor) and liquid moisture.

It should be noted that, in a case that two or more kinds of gases are sealed in the disk device 1, the first property may be a gas barrier property for at least one kind of the gases. The gas barrier property for at least one kind of the gases may correspond to characteristics or the like required for the disk device 1. The first property may be the vapor barrier property and the second property may be the gas barrier property. Further, the first property and the second property are not limited to the gas barrier property and the vapor barrier property, may be various kinds of properties such as hardness, peel strength, viscosity, heat resistance, pressure resistance and the like, and should be provided in both the outer gasket portion 23 and the inner gasket portion 25 while being hard to be compatible in a level required for the disk device 1.

In the gasket 21, the outer gasket portion 23 and the inner gasket portion 25 supplement each other in inferior properties that are the vapor barrier property and the gas barrier property. This achieves both the properties hard to be compatible in a level required for the disk device 1. Namely, the embodiment adapts to a case requiring properties hard to be compatible for the gasket 21 of the disk device 1.

Additionally, both the outer gasket portion 23 and the inner gasket portion 25 have the gas barrier property and the vapor barrier property and should supplement each other in the inferior properties. Thus, the gasket 21 is prevented from being increased in size as a whole.

Namely, the outer gasket portion 23 and the inner gasket portion 25 are provided in degrees to supplement each other in the inferior properties, thereby to allow the gasket 21 to achieve both the gas barrier property and the vapor barrier property as a whole while the outer gasket portion and the inner gasket portion are reduced in size, respectively. The degrees to supplement each other in the inferior properties are set according to dimensions of the outer gasket portion 23 and the inner gasket portion 25 in the thickness direction and the intersecting direction, contacting areas of the outer gasket portion and the inner gasket portions against the cover body 19 and the gasket-receiving portion 17, and the like.

Further, both the outer gasket portion 23 and the inner gasket portion 25 in the gasket 21 of the present embodiment are held between the cover body 19 and the gasket-receiving portion 17. Thus, each of the outer gasket portion 23 and the inner gasket portion 25 is in closely contact with the cover body 19 and the gasket-receiving portion 17, so that the gasket 21 as a whole surely achieves both the gas barrier property and the vapor barrier property.

FIG. 5 is a schematic sectional view illustrating a gasket and a periphery thereof of a disk device according to the embodiment 2 of the present invention with enlargement. In addition, the embodiment 2 is common with the embodiment 1 in the basic structure and corresponding components are represented with the same reference numerals to eliminate duplicate explanation.

The present embodiment forms a boundary face 27 between an outer gasket portion 23 and an inner gasket portion 25 into a curved shape.

The outer gasket portion 23 has a cross section of an approximate oval shape, and the inner gasket portion 25 covers an inner side of the outer gasket portion 23 so that the gasket 21 has a cross section of an approximate oval shape as a whole. With this, the boundary face 27 has a cross section with an arc shape as the curved shape. It should be noted that the cross section of the outer gasket portion 23 and the cross section of the inner gasket portion 25 may be reversed.

According to the embodiment, an outer end of the inner gasket portion 25 in the intersecting direction relative to the thickness direction is held between an inner end of the outer gasket portion 23 and a cover body 19 and between the inner end of the outer gasket portion 23 and a gasket-receiving portion 17. On the other hand, the inner end of the outer gasket portion 23 in the intersecting direction is held by the outer end of the inner gasket portion 25 in the intersecting direction.

As this result, a close contact state between the outer gasket portion 23 and the inner gasket portion 25 is kept. Others are the same as of the embodiment 1.

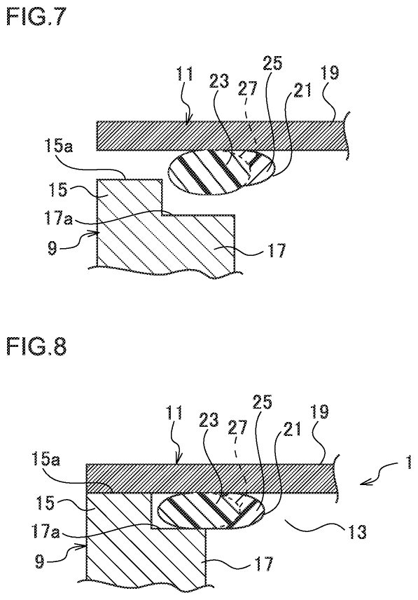

FIG. 6 is a schematic sectional view illustrating a gasket and a periphery thereof of a disk device according to the embodiment 3 of the present invention with enlargement, and FIG. 7 is a schematic sectional view illustrating a portion corresponding to FIG. 6 in a state before a cover is attached. In addition, the embodiment 3 is common with the embodiment 2 in the basic structure and corresponding components are represented with the same reference numerals to eliminate duplicate explanation.

In the present embodiment, a gasket-receiving portion 17 of a base 9 is formed shorter in an intersecting direction relative to a thickness direction. According to this, an inner gasket portion 25 is partially protruded from the gasket-receiving portion 17 toward a space 13 in the intersecting direction. Namely, an outer gasket portion 23 and part of the inner gasket portion 25 are held between a cover body 19 of a cover 11 and the gasket-receiving portion 17 of the base 9.

Accordingly, the present embodiment sets a more important property of a gas barrier property and a vapor barrier property as a first property that is superior in the outer gasket portion 23 having a larger contact area with respect to the gasket-receiving portion 17. It should be noted that the vapor barrier property may be more important property according to characteristics, a use area or the like of a disk device 1.

The outer gasket portion 23 is higher than the inner gasket portion 25 in height from the cover body 19 in a free state. With this, the outer gasket portion 23 and the inner gasket portion 25 have the same height in a held state between the cover body 19 of the cover 11 and the gasket-receiving portion 17 of the base 9. In addition, the height of the gasket 21 is the height in the thickness direction of the disk device 1.

The heights of the outer gasket portion 23 and the inner gasket portion 25 in the held state are the same as a dimension between the cover body 19 and the gasket-receiving portion 17 in the thickness direction. Accordingly, both the outer gasket portion 23 and the inner gasket portion 25 are arranged within a range between the cover body 19 and the gasket-receiving portion 17.

Thus, although the inner gasket portion 25 has part not to be held between the cover body 19 and the gasket-receiving portion 17, the whole gasket 21 including the inner gasket portion 25 is prevented from protruding toward a disk 5 in the thickness direction. Others are the same as of the embodiment 2.

It should be noted that the structure of the embodiment 3 is applicable to the embodiment 1 in which the boundary face 27 between the outer gasket portion 23 and the inner gasket portion 25 is along the thickness direction and to the embodiment in which the outer gasket portion 23 and the inner gasket portion 25 are mixed at a boundary and have no boundary face.

FIG. 8 is a schematic sectional view illustrating a gasket and a periphery thereof of a disk device according to the embodiment 4 of the present invention with enlargement. In addition, the embodiment 4 is common with the embodiment 3 in the basic structure and corresponding components are represented with the same reference numerals to eliminate duplicate explanation.

In the present embodiment, a gasket-receiving portion 17 of a base 9 is formed even shorter than of the embodiment 3 in an intersecting direction relative to a thickness direction. According to this, an inner gasket portion 25 is entirely protruded from the gasket-receiving portion 17 toward a space 13 in the intersecting direction. Accordingly, only an outer gasket portion 23 is held between a cover body 19 and the gasket-receiving portion 17 in the present embodiment.

An inner side of the outer gasket portion 23 is covered with the inner gasket portion 25 in a degree to supplement a second property being relatively inferior in the outer gasket portion 23. The covering in this context is that the outer gasket portion is prevented from being exposed to the space 13 in the same way as the embodiment 1. According to the present embodiment, part of the inner side of the outer gasket portion 23 is not covered with the inner gasket portion 25 and is exposed to the space 13 of a housing 3 together with the inner gasket portion 25.

It should be noted that the inner gasket portion 25 may be configured to cover the entire inner side of the outer gasket portion 23 so as not to expose the outer gasket portion 23 to the space 13 of the housing 3.

Further, the height of the outer gasket portion 23 may be lower than the height of the inner gasket portion 25 in a held state of the outer gasket portion 23 and the inner gasket portion 25 between the cover body 19 of the cover 11 and the gasket-receiving portion 17 of the base 9. The height of the inner gasket portion 25, however, increases or decreases the amount of the exposure of the outer gasket portion 23 to the space 13 and therefore should be in a range to supplement a second property of the outer gasket portion 23.

Others are the same as of the embodiment 3. It should be noted that the structure of the embodiment 4 is applicable to the embodiment 1 in which the boundary face 27 between the outer gasket portion 23 and the inner gasket portion 25 is along the thickness direction and to the embodiment in which the outer gasket portion 23 and the inner gasket portion 25 are mixed at a boundary and have no boundary face.

1. A cover attached to a base of a recording device to close the base, comprising:
a cover body;
a gasket having a loop shape and provided to the cover body, wherein
the gasket has an inner gasket portion and an outer gasket portion arranged adjacent to each other on an inward side and an outward side of the loop shape,
the outer gasket portion has a first property and a second property that are different properties and is superior to the inner gasket portion in the first property, and
the inner gasket portion has the first property and the second property and is superior to the outer gasket portion in the second property.

2. The cover according to claim 1, wherein
the first property is one of a gas barrier property and a vapor barrier property, the gas barrier property being hardness of permeation of gas sealed in the recording device and the vapor barrier property being hardness of permeation of moisture, and
the second property is the other of the gas barrier property and the vapor barrier property.

3. The cover according to claim 1, wherein
the first property is the gas barrier property, and
the second property is the vapor barrier property.

4. The cover according to claim 1, wherein
the outer gasket portion is higher than the inner gasket portion in height from the cover body in a free state.

5. The cover according to claim 1, wherein
the outer gasket portion and the inner gasket portion are provided in degrees to supplement each other inferiors of the first property and the second property.

6. A recording device having the cover according to claim 1, comprising:
a base to which the cover is attached to be closed; and
a gasket-receiving portion provided to the base to hold the gasket between the cover body and the gasket-receiving portion.

7. The recording device according to claim 6, wherein
both the outer gasket portion and the inner gasket portion of the gasket are held between the cover body and the gasket-receiving portion.

8. The recording device according to claim 6, wherein
only the outer gasket portion is held between the cover body and the gasket-receiving portion.

9. The recording device according to claim 6, wherein
both the outer gasket portion and the inner gasket portion are located in a range of an interspace between the cover body and the gasket-receiving portion.
